(19) United States
(12) Patent Application Publication
(10) Pub. No.: US 2015/0310206 A1
(43) Pub. Date: Oct. 29, 2015

(54) PASSWORD MANAGEMENT

(71) Applicant: International Business Machines Corporation, Armonk, NY (US)

(72) Inventors: Philippe Kaplan, LE ROURET (FR); Georges-Henri Moll, VILLENEUVE-LOUBET (FR); Xavier Nodet, ANTIBES (FR); Olivier Oudot, VALLAURIS (FR)

(21) Appl. No.: 14/629,568

(22) Filed: Feb. 24, 2015

(30) Foreign Application Priority Data
Apr. 24, 2014 (GB) 1407198.9

(51) Int. Cl. G06F 21/46; H04L 9/32; H04L 9/08; G06F 21/31; G06F 21/60

(52) U.S. Cl. CPC G06F 21/46; G06F 21/31; G06F 21/602; H04L 9/0869; H04L 9/3226; H04L 2209/56

(57) ABSTRACT

A method of generating a password. An embodiment includes: receiving a first user input defining a seed for the password, receiving a second user input defining a destination for the password, operating a coding function to generate the password from the first user input and the second user input, and outputting the password generated by the coding function.

### TECHNICAL FIELD

This disclosure relates to a method of, and system for, managing multiple passwords.

### BACKGROUND

The multiplicity of password protected websites, applications and remote services, as well as credit cards and ATMs, etc. means that individuals have to remember a huge number of passwords. For most individuals this can be of the order of 10 to 20 different passwords, which can be very difficult for the average individual to remember. In order to overcome this problem, many individual use dangerous single passwords for multiple sites, or use tricks with prefixes or postfixes, still with a single (and hence vulnerable) password core.

There are known solutions to such problems. One common solution used in enterprise situations is the single sign on technique. The principle of this solution is that the access control is centralized. The drawbacks include the fact that this is only possible within one company, and security is compromised if the password is captured by a malevolent third party since all accesses are compromised and recovery is difficult if the password is lost. One solution for individuals is the use of a password manager (also known as a password vault or an encrypted password database. The principle of this solution includes the provision of a local or remote personal database of passwords, itself protected by a unique password. Drawbacks include the lack of security since if the password is stolen, all passwords are compromised, recovery is very difficult since all passwords need to be reset, and to ensure ubiquity the user needs to synchronise the manager on multiple devices such as a mobile phone, PC, and touchpad.

### SUMMARY

According to a first aspect, there is provided a method of generating a password, the method comprising: receiving a first user input defining a seed for the password; receiving a second user input defining a destination for the password; operating a coding function to generate the password from the first user input and the second user input; and outputting the password generated by the coding function.

According to a second aspect of the present invention, there is provided a system for generating a password, the system comprising: a user interface arranged to receive a first user input defining a seed for the password and receive a second user input defining a destination for the password; and a processor arranged to operate a coding function to generate the password from the first user input and the second user input, and output the password generated by the coding function.

According to a third aspect of the present invention, there is provided a computer program product on a computer readable medium for generating a password, the product comprising instructions for: receiving a first user input defining a seed for the password; receiving a second user input defining a destination for the password; operating a coding function to generate the password from the first user input and the second user input, and outputting the password generated by the coding function.

Owing to the invention, it is possible to provide a method and system for generating multiple different passwords that is secure and does not require the storage of any passwords but is also easy to use and does not place undue reliance on the user's memory. Instead of keeping passwords in a protected database, the method generates them from a seed (such as a personal long passphrase) and a keyword, with a coding function such as a public (or private) cryptographic hash function.

The improved solution may use, for example, a hashing function as a password generator that calculates passwords as hashcode from a seed concatenated with a keyword. The function may include the following properties in that it is deterministic and can recalculate the password whenever it is wanted, provided the user knows the seed and the keyword, it easy to compute, a user can run it on a mobile phone, it is not reversible in that no one can compute the seed from the keyword and hashcode, and it is not an injective function in that two messages can have the same hash so no one can test the seed from a keyword and hashcode pair. Non-injective encryption functions can also be used as the coding function.

The method and system has numerous advantages. For example, on the security side nothing is stored on any device, so if a user's mobile phone (for example) is stolen then the user is not in danger of seeing their accounts accessed fraudulently. Irreversibility ensures that the user's seed cannot be deduced from a keyword/hashcode pair and injectivity ensures that seeds cannot be tested from a keyword/hashcode pair. The improved method and system also has good recovery characteristics in that as long as the user can remember their passphrase (seed) and their keywords, they can re-generate all the exact same passwords. The password generator can be embodied in a simple application and the user just has to download the application to their device (PC, mobile phone, tablet, or other dedicated device), or access an online application. The user can even access another person's device to access the application. The improved method also delivers excellent ubiquity in that even if a user does not have access to their device, they can quickly install the application on any device to regenerate my passwords and no synch is needed.

The method may further comprise receiving a third user input defining one or more constraints for the password and operating the coding function according to the defined constraint(s). Since it is common for services to specify requirements in relation to their passwords, the user may specify one or more constraints, which are then taken into account, when the password is generated by the coding function. For example, a user's bank account may only be accessible online using a password that includes a letter, a number and a special character (e.g., one that is not alphanumeric). These constraints may be specified by the user when they input their passphrase and keyword (e.g., an identifier for the bank) into the password generator and the resulting password generated by the coding function will comply with the specified constraints, in order to be usable with the specific online banking application. This ensures that the password generator is applicable in all situations where a password is needed. A user may then access all of their services using the password generator, which means that they only have to remember their own passphrase, but multiple unique passwords are generated for all of their services.

The method may further comprise providing a graphical user interface for receiving the first user input defining a seed for the password and the second user input (keyword) defining a destination for the password. The graphical user interface may also be further provided for receiving the third user input defining one or more constraints for the password. The provision of a simple graphical user interface as the front end for a downloadable application provides a simple and efficient method by which a user can access the password generator. The graphical user interface provides the user with fields to complete for the seed and the destination of the password and can generate the password instantly and output the generated password in the graphical user interface. Any time that the user inputs the same seed and keyword pair, then the coding function will generate the same password and the graphical user interface will display that for the user.

The graphical user interface may also be configured to accept the constraints that may be needed for the specific application. For example, check boxes may be provided in the graphical user interface which the user will check as appropriate in a common user interface interaction. So, for example, there could be a check box for “at least one number required”, which should the user select this check box, will ensure that the password generated and displayed in the graphical user interface contains at least one number, as required. All other constraints can be captured in the same way and these different constraints can be used in combination, as required by particular application. All constraints can be captured, such as specific characters and length of password, for example. The user selects the relevant check boxes in the graphical user interface and the required password is generated accordingly.

### BRIEF DESCRIPTION OF THE DRAWINGS

Embodiments will now be described, by way of example only, with reference to the following drawings.

FIG. 1 is a schematic diagram of a user with a mobile device and computer.

FIG. 2 is a schematic diagram of a graphical user interface of a password generation application.

FIG. 3 is a schematic diagram of a hash function.

FIG. 4 is a schematic diagram of inputs to a hash function.

FIG. 5 is a flowchart of a method of generating a flowchart.

FIG. 6 is a schematic diagram of a second embodiment of a graphical user interface of a password generation application.

### DETAILED DESCRIPTION

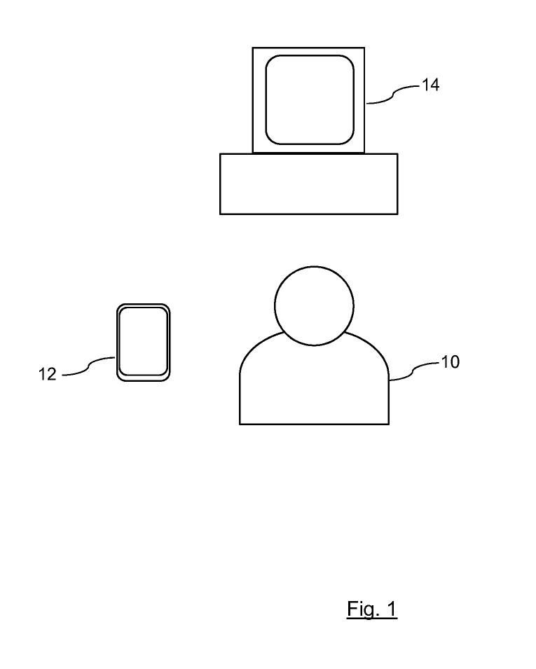

FIG. 1 shows a user 10 who has a mobile device 12 and also has access to a computer 14, which is connected to the Internet. The user 10 is using the computer 14 to access, for example, their bank account. Through an Internet browser installed on the computer 14, the user 10 can navigate to the bank's website. The user 10 can then log into their account through the bank's website. This login process typically requires at least one password and may also require the user 10 to navigate other security features, such as by answering questions or inputting numbers generated by a card reader that reads the user's bank card.

However, in relation to the user's password, it is of vital importance that the user 10 has a secure password (that cannot be guessed) which is also unique to the specific bank of the user 10. Most users do not satisfy either of these conditions since they have to use more than ten passwords in their normal personal and business life and they will either re-use the same simple password for multiple services or will only use passwords that are only simple variants of each other. This makes these passwords vulnerable to malicious discovery, since passwords can be guessed or discovered through the similarities between passwords used for different services.

Here, though, the user 10 is using an application stored on their mobile phone 12, which allows the user 10 to generate secure unique passwords for each of the different services that they access, without the need for the user 10 to either remember or store the individual passwords. The user 10 may remember one single passphrase (which is referred to as a “seed” for the process) and a keyword comprising, for example, an identifier for the specific service being accessed. These two things together are inputted by the user at the moment when the password is needed and used by the application to generate the password for access to the user's bank account, via the bank's website.

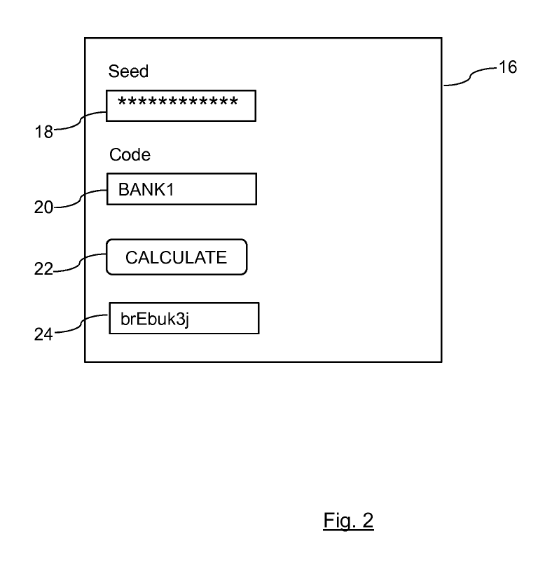

FIG. 2 is a screenshot of a graphical user interface 16 of the application. The user 10 may see the graphical user interface 16, for example, when the user 10 accesses the application on their mobile phone 12 or other device. The application can be downloaded from a suitable supplier and installed onto the user's mobile phone 12, as is conventional with mobile phone apps, or may be provided in any other suitable manner. The application is executed by the processor of the mobile phone 12. The graphical user interface 16 shows a first field 18, a second field 20, a virtual button 22, and an output field 24, which together make up the graphical user interface 16. Modern mobile phones are provided with sophisticated touchscreens that allow a user to interact with a graphical user interface 16 in a simple and straightforward manner.

Once the user 10 wishes to access their bank's website through the computer 14, then they will launch the password application and will access the graphical user interface 16. The user 10 then firstly inputs their seed into the first field 18 and secondly inputs a keyword (e.g., their term for the destination of the resulting password) into the second field 20. In this example, the user 10 has chosen the input “BANK1” as the shorthand code for the destination of the password. That is, the keyword is “BANK1.” The user 10 then “presses” the virtual button 22 and the application generates the password, which is here shown as “brEbuk3j” in the output field 24. The generated password is shown in the graphical user interface 16.

Whenever the user 10 wishes to access their bank's website and login to their account then they can repeat this process through the graphical user interface 16 of the application on their mobile phone 12 and the required password will be reproduced. The same seed and keyword pairing will always generate the same password (the underlying coding function being deterministic). The generated password is not stored anywhere and so there is no actual record of the password that could be hacked or discovered. The password will be unique for the specific use, as the keyword will be different for a different application, although the seed will be the same.

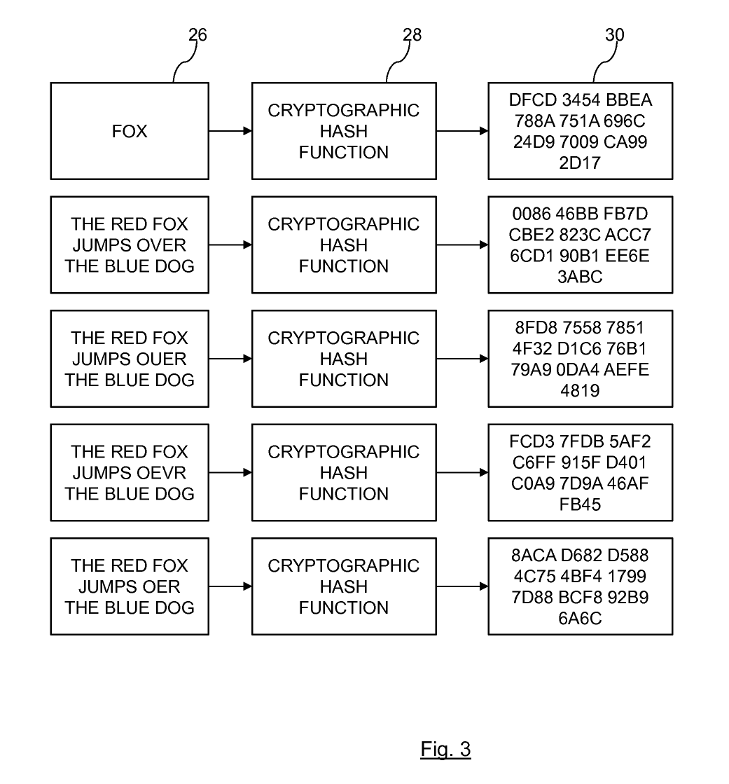

FIG. 3 illustrates the concept of a cryptographic hash function, that may be used by the application that the user has stored on their mobile phone 12. A hash function may be used as the coding function. The input 26 is processed by the hash function 28 to produce an output 30. The same input 26 will always produce the same output 30, but small changes in the input 26 will radically change the output 30, as is shown in FIG. 3. Two different inputs 26 can produce the same output 30, but this is not material as far as the use of a hashing function is concerned in this context. The hash function 28 essentially changes the input 26 into the output 30.

Hash functions are typically not invertible, meaning that it is not possible to reconstruct the input 26 from the output 28 alone. For cryptographic uses, hash functions are designed in such a way that is impossible to reconstruct an input 26 from the output 28 alone, without expending large amounts of computing time. This ensures that even if a password for a user 10 becomes insecure for any reason, that password alone cannot be used to work out the users seed, which is the most crucial part of the methodology in security terms. The user can simply adjust the keyword if the password becomes insecure and a new password will be generated.

Two such known cryptographic hash functions are MD5 and SHA-1. The function MD5 is a message-digest algorithm that is a widely used cryptographic hash function producing a 128-bit (16-byte) hash value, typically expressed in text format as a 32 digit hexadecimal number. MD5 is utilised in a wide variety of cryptographic applications. SHA-1 is a cryptographic hash function that produces a 160-bit (20-byte) hash value. A SHA-1 hash value typically forms a hexadecimal number, 40 digits long. SHA stands for “secure hash algorithm”. These two functions are examples of hash functions that can be used in the password generating application as a way of ensuring that the output 30 is secure.

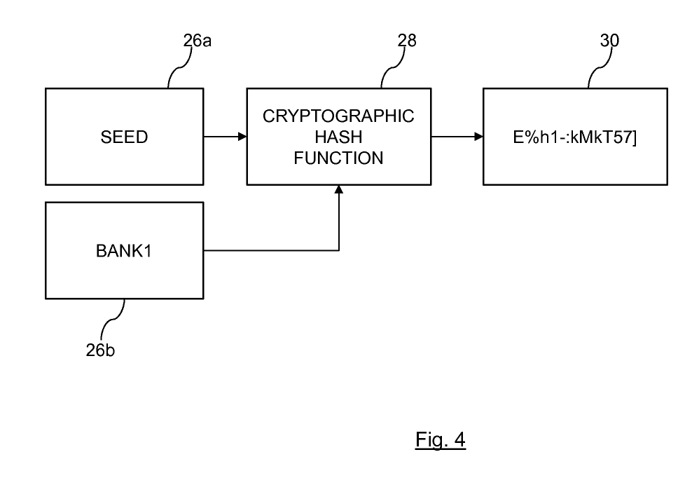

A hashing function 28 used by the application on the mobile phone 12 is shown in FIG. 4. The hashing function 28 produces an output 30 from two inputs 26a and 26b. The two inputs are the user's seed 26a and a keyword 26b. The seed 26a is the user's secure passphrase and the keyword 26b is the user's shorthand for the destination of the password. These two together are used by the hashing function 28 to produce the password 30. Whenever the user 10 inputs the same seed and keyword pairing then the same password 30 will be produced. The user 10 does not need to know anything concerning the operation of the hashing function 28.

The hashing function 28 operates as a password generator that generates a password 30 from the seed 26a concatenated with the keyword 26b. The hashing function 28 is deterministic and can recalculate the password 30 whenever it is needed, provided the user 10 remembers the seed 26a and the keyword 26b. The function is easy to compute, since the user 10 can run it on their mobile phone 10 and it is not reversible since nobody can work out the seed 26a from the keyword 26b and password 30 and it is not an injective function in that two inputs 26 can have the same output 30 so nobody can test the seed 26a from a keyword 26b and password pair.

Numerous advantages are provided. Nothing is stored on any device, so if the user's mobile phone 12 is stolen then the user 10 is not in danger of seeing their accounts accessed fraudulently. There are also has good recovery characteristics in that as long as the user can remember their passphrase (seed 26a) and their keywords 26b, they can re-generate all the exact same passwords. The password generator 28 can be embodied in a simple mobile phone application and the user 10 just has to download the application to their device whether a PC, mobile phone, tablet, or other device, or access an online app. The user can even access the application from another person's device.

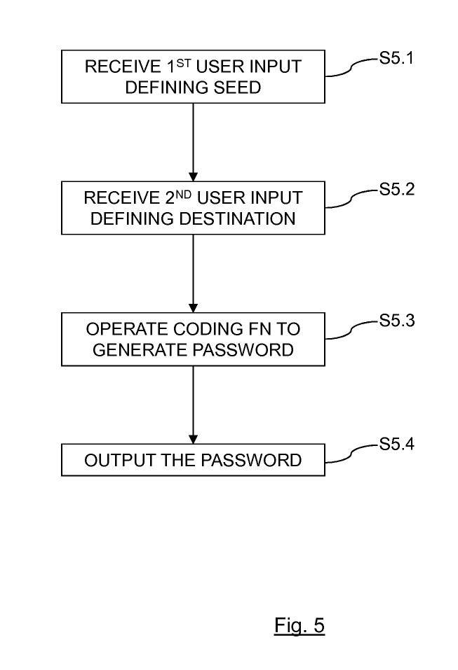

FIG. 5 shows a flowchart summarising the method of generating the password 30, which is executed by the application on the user's mobile phone 12 (or wherever the application is being executed). The method comprises the steps of, firstly step S5.1 receiving a first user input 26a defining a seed for the password 30, secondly step S5.2 receiving a second user input 26b (keyword) defining a destination for the password, thirdly step S5.3 operating a coding function 28 to generate a password 30 from the first user input 26a and the second user input 26b, and finally step S5.4 outputting the password 30 generated by the coding function 28.

This method may be embodied in the application as a software solution but could also be provided by a purpose-built device similar to a small hand-held calculator that will allow a user to input the seed 26a and keyword 26b and provide the password 30 to the user via a small screen. The user could also access the process via a dedicated website, although this is not ideal from a security perspective as the user's seed 26a (even if encrypted) would be being sent over an interceptable network and could be vulnerable to malicious access. One solution is that the user 10 installs the application on a device that is local to them and accesses the application as and when needed.

If the user needs one of their passwords at any time and they do not have direct access to the password generating application, then they can always download a copy of the application to a local device. Since it is implicit that to be able to input a password to access a service the user 10 must be using some kind of computing device, then they can download a copy of the application to that device, even if purely as a temporary solution. This means that they can use computers in foreign countries for example, where they might be on holiday or on business and they do not have suitable connectivity through their normal mobile device.

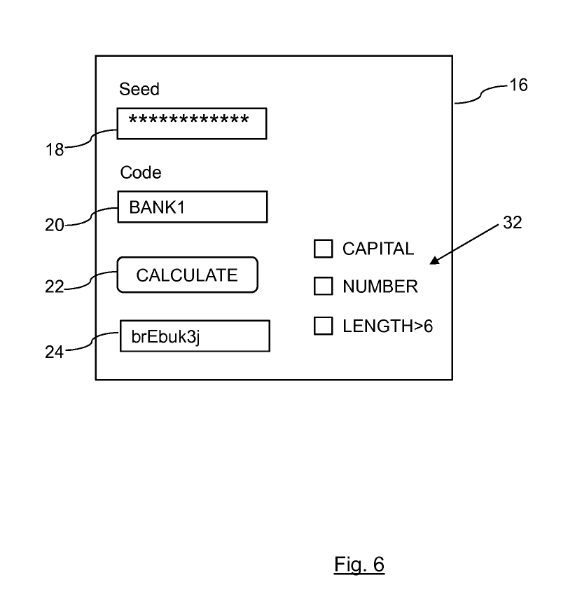

FIG. 6 shows a second embodiment of the graphical user interface 16 to the application that is embodying the password generator. This improved graphical user interface 16 is similar to that shown in FIG. 2, except that this graphical user interface 16 allows the user 10 to define one or more constraints 32 for the password being generated and the hash function is then operated according to the defined constraints 32. This embodiment is designed to allow the user 10 to specify constraints 32 on the password 30 being outputted by the hashing function 28 in order to provide additional flexibility in the password generation process.

The addition of the constraints 32 is to cover the possibility that the service that the user 10 is accessing has specified rules that have to be followed by the password 30 chosen by the user 10. In order to try and strengthen the passwords selected by users, services often apply rules to the permissible passwords. For example, the constraints 32 covered in FIG. 6 include the requirement that a capital letter be used in the password, a number be used in the password and that the password is of a minimum length. These are all common rules required by services in relation to user defined passwords used for accessing such services.

The three constraints 32 shown in FIG. 6 are only listed to illustrate the concept of constraints 32 being used by the password generator when it is operated to generate a password 30. Obviously it would be desirable if the password generator can cover all possible constraints that are known to be used in password selection. The hashing function 28 is then modified in a defined and controlled manner according to the constraint(s) 32 selected by the user 10, in order to ensure that the principle of the process being deterministic is maintained. The same password 30 will always be outputted for the same seed 26a, same keyword 26b, and same constraint combination inputted by the user 10.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fibre-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibres, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual skilled in the art are included within the scope of the invention as defined by the accompanying claims.

1. A method of generating a password, the method comprising:
receiving a first user input defining a seed for the password;
receiving a second user input defining a destination for the password;
operating a coding function to generate the password from the first user input and the second user input; and
outputting the password generated by the coding function.

2. The method according to claim 1, further comprising:
receiving a third user input defining at least one constraint for the password; and
operating the coding function according to the at least one defined constraint.

3. The method according to claim 1, wherein the second user input defining the destination for the password comprises a keyword.

4. The method according to claim 1, further comprising:
providing a graphical user interface for receiving the first user input defining the seed for the password and the second user input defining the destination for the password.

5. The method according to claim 1, further comprising:
receiving a third user input defining at least one constraint for the password; and
operating the coding function according to the at least one defined constraint.

6. The method according to claim 5, further comprising:
providing a graphical user interface for receiving the first user input defining the seed for the password, the second user input defining the destination for the password, and the third user input defining the at least one constraint for the password.

7. The method according to claim 1, wherein the coding function comprises a hashing function for generating a hashcode from the seed concatenated with the keyword.

8. A system for generating a password, the system comprising:
a graphical user interface for:
receiving a first user input defining a seed for the password; and
receiving a second user input defining a destination for the password,
and
a processor for:
operating a coding function to generate the password from the first user input and the second user input; and
outputting the password generated by the coding function.

9. The system according to claim 8,
wherein the graphical user interface is further configured for:
receiving a third user input defining at least one constraint for the password;
and
wherein the processor is further configured for:
operating the coding function according to the at least one defined constraint.

10. The system according to claim 8, wherein the second user input defining the destination for the password comprises a keyword.

11. The system according to claim 8, wherein the coding function comprises a hashing function for generating a hashcode from the seed concatenated with the keyword.

12. A computer program product on a computer readable medium for generating a password, the program product comprising instructions for:
receiving a first user input defining a seed for the password;
receiving a second user input defining a destination for the password;
operating a coding function to generate the password from the first user input and the second user input; and
outputting the password generated by the coding function.

13. The computer program product according to claim 12, further comprising instructions for:
receiving a third user input defining at least one constraint for the password; and
operating the coding function according to the at least one defined constraint.

14. The computer program product according to claim 12, wherein the second user input defining the destination for the password comprises a keyword.

15. The computer program product according to claim 12, further comprising instructions for:
providing a graphical user interface for receiving the first user input defining the seed for the password and the second user input defining the destination for the password.

16. The computer program product according to claim 12, further comprising instructions for:
receiving a third user input defining at least one constraint for the password; and
operating the coding function according to the at least one defined constraint.

17. The computer program product according to claim 16, further comprising instructions for:
providing a graphical user interface for receiving the first user input defining the seed for the password, the second user input defining the destination for the password, and the third user input defining the at least one constraint for the password.

18. The computer program product according to claim 12, wherein the coding function comprises a hashing function for generating a hashcode from the seed concatenated with the keyword.
